(19) United States
(12) Patent Application Publication
(10) Pub. No.: US 2008/0123602 A1
(43) Pub. Date: May 29, 2008

(54) METHOD AND SYSTEM FOR CHANNEL QUALITY ESTIMATION

(75) Inventors: Jaap van de BEEK, Stockholm (SE); Mattias WENNSTROM, Stockholm (SE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/956,985

(22) Filed: Dec. 14, 2007

Related U.S. Application Data
(63) Continuation of application No. PCT/CN2005/000858, filed on Jun. 15, 2005.

(51) Int. Cl. H04Q 7/20; H04B 7/02

(52) U.S. Cl. 370/336; 375/267

(57) ABSTRACT

The present invention relates to a method for channel quality estimation in a wireless data communication system, wherein data streams are transmitted from a transmitter having multiple antennas and/or antenna elements to a receiver over a frequency band, wherein, during a first period of time, data streams are transmitted on at least one sub-band of the frequency band using a first beamforming constellation, and wherein, during a subsequent second period of time, data streams are transmitted on said sub-band using a second beamforming constellation. The method further includes a training step, during the first period of time, wherein a data stream is transmitted on a portion of, or adjacent to, said sub-band while using the beamforming constellation to be used in said second period of time. The present invention also relates to a system, a transmitter and a communication system.

### CROSS-REFERENCE TO RELATED APPLICATIONS

This application is a continuation of International Application No. PCT/CN2005/000858, filed Jun. 15, 2005, the content of which is incorporated herein by reference.

### FIELD OF THE INVENTION

The present invention relates to the field of radio communication systems, and in particular to a channel quality estimation method, especially for packet-based, multi-user cellular communication systems.

### BACKGROUND OF THE INVENTION

In packet-based, multi-user cellular communication systems, such as multi-user OFDM (Orthogonal Frequency Division Multiplexing) systems, a scheduler-device that makes decisions as to which user is assigned which radio resources and when is typically employed. From time to time, users report the quality of their respective radio channels to the base station, upon which the base station makes a scheduling decision. The scheduler may exploit the fact that the users' channels change independently from each other, i.e., channels of one or more users may be fading, or, also, one or more channels allocated to a specific user may be fading, while others are not. Typically, a user is assigned radio resources when its channel conditions are good. Accordingly, the scheduler improves the performance of the system (in terms of cell throughput) as compared to systems that do not exploit the users' channel quality through a scheduler.

The extent to which the scheduler improves the system performance depends on the richness of the channel, i.e., how much and how often the channels vary in time. When the channels do not vary (or vary very slowly), e.g., the users are standing still or walking, the gain is smaller than in a rich channel environment, e.g., users travelling in vehicles.

This has led to the concept of random beamforming (see, for example, P. Visnawath, D. Tse and R. Laroia, “Opportunistic beamforming using dumb antennas”, IEEE Transactions on information theory, pp. 1277-1294, June 2002), wherein a base station induces channel richness artificially through the use of two transmitter antennas, which transmit the same data with a relative phase that changes each time slot. This yields randomly directed beams, having a similar effect on the users' channel quality as channel fading would have. The effective gain of this technique becomes apparent when the number of users in the cell exceeds a certain critical number.

Not only does the random beamforming yield an instantaneous beamforming gain for some users in the cell, it also instantaneously improves the interference characteristics for some users in the cell, since neighbouring cells (also employing random beamforming) may instantaneously point in other directions. Consequently, the random beamforming concept creates channel richness through a beamforming gain and through interference nulling.

A problem with random beamforming, however, is that the users in a cell need to know their respective channel quality, and report it to the base station, one or more time slots in advance. The random character of the beamforming makes it impossible for the users to anticipate on the channel quality (especially the interference from other cells) without some form of training.

This is a general problem for systems employing random beamforming, and specifically for systems based on OFDM modulation.

In P. Svedman, ‘Multiuser diversity orthogonal frequency division multiple access systems’ licentiate thesis, Royal Institute of Technology, Stockholm, Sweden, 2004, an attempt to solve this problem is disclosed. A short pause is introduced in the data-transmission in each time slot, during which the synchronized base stations in the whole system transmit a training signal employing the beamforming configuration that is going to be used in the next time slot. This enables all users in the cell to assess the channel quality that will govern the transmission during the next time slot, provided that the radio channel does not fade too fast, and to report a channel quality measurement to the base station in advance.

One disadvantage with solution, however, is that data cannot be transmitted continuously.

### SUMMARY OF THE INVENTION

According to one aspect of the present invention, a channel estimation method for use in a packet-based, multi-user cellular communication system is provided.

According to another aspect of the present invention, a system for channel estimation for use in a packet-based, multi-user cellular communication system is provided.

In accordance with embodiments of the present invention, data streams are transmitted from a transmitter to a receiver over a frequency band, wherein, during a first period of time, data streams are transmitted on at least one sub-band of the frequency band using a first beamforming constellation, and wherein, during a subsequent second period of time, data streams are transmitted on said sub-band using a second beamforming constellation. The method includes a training step, during the first period of time, wherein a data stream is transmitted on a portion of, or adjacent to, said sub-band while using the beamforming constellation to be used in said second period of time.

One of the above technical schemes has the following advantages or advantageous effect: data transmission may be performed continuously, without interruption for the transmission of a training signal. Further, since only a portion of said sub-band is used for transmission of the training signal, throughput in the system can be increased. Even further, since only a portion of said sub-band is used for transmission using beamforming constellation of a subsequent period of time, the time this transmission is in progress may be substantially longer as compared to the prior art, which has the advantage that time-synchronisation requirements in the communication system can be reduced.

Two or more sub-bands may be assigned the same beamforming constellation, this has the advantage that data throughput may be increased, since less capacity is needed for signalling.

At least two data streams may be transmitted simultaneously in a sub-band, wherein said beamforming constellation is different for each data stream. This has the advantage that system capacity may be increased even further, since two or more beams may be used simultaneously.

At least two measurements may be transmitted from the receiver during the time interval data is transmitted using a beamforming constellation of the second period of time. This has the advantage that if the channel changes during said time interval, this may be reported to the base station.

At least one indication as to whether channel quality has improved or degraded since a measurement was transmitted to the system may be transmitted to the transmitter. This has the advantage that the actual channel quality during said second period of time can be predicted with a greater certainty.

On another hand, an embodiment of the present invention further provides a transmitter and a multi-user cellular communication system.

Further advantages and features of the present invention will be disclosed in the following detailed description.

### BRIEF DESCRIPTION OF THE DRAWING(S)

FIG. 1 shows a prior art method of transmitting a training signal in a system employing random beamforming.

FIG. 2 shows a communication resource scheme which advantageously may be used with the present invention.

FIG. 3 shows an exemplary method of transmitting a training signal in accordance with the present invention.

FIGS. 4a-b show other exemplary embodiments of the present invention.

FIG. 5 shows a further exemplary embodiment of the present invention.

### DETAILED DESCRIPTION OF PREFERRED EMBODIMENTS

As was mentioned above, use of random beamforming in a packet-based multi-user cellular communication system yields an instantaneous beamforming gain for some users in a cell, while at the same time it also instantaneously improves the interference characteristics for some users in the cell, thus creating channel richness.

When using random beamforming, at least two transmitter antennas (or antenna elements) are used to randomly direct the antenna beam in a certain direction using a beamforming constellation, such as amplitude and relative phase difference between the transmitter antennas. After a certain time, for example, every time slot or after a predetermined number of time slots in a time slotted system, the beamforming constellation is changed and, accordingly, the beam is directed in another direction.

As was also mentioned above, in order to fully benefit from random beamforming, the system needs to know which channel quality the users will experience in a certain time slot employing a certain beamforming constellation. Consequently, the users need to know their respective channel quality, and report it to the base station, before the beamforming constellation actually is being used, and without knowing which beamforming constellation that is going to be used (due to the random selection of beamforming constellation in each time slot). The feed-back reporting is necessary since it is when a beam is directed directly, or substantially directly, towards a particular user, a high channel quality is experienced by that user.

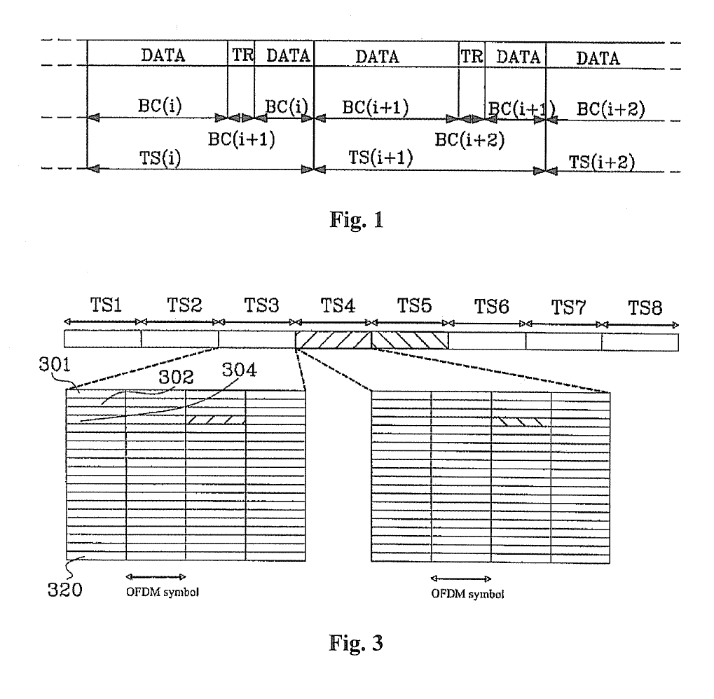

An attempt to solve this problem is disclosed in P. Svedman, ‘Multiuser diversity orthogonal frequency division multiple access systems”, licentiate thesis, Royal Institute of Technology, Stockholm, Sweden, 2004. An example of the system described therein is shown in FIG. 1.

In the system shown in FIG. 1, data is transmitted in time slots TS. During a particular time slot TS(i), TS(i+1), TS(i+2) . . . , data is transmitted using a certain beamforming constellation BC(i), BC(i+1) BC(i+2) . . . . In order to perform an efficient scheduling for TS(i+1), i.e. use available resources as efficient as possible, the scheduler needs to know an estimate of the channel quality in TS(i+1) for each user in the coverage area of the base station. In order to obtain reliable channel quality estimates for TS(i+1), a portion TR of TS(i) is used for transmission of training symbols using the beamforming constellation BC(i+1) to be used in TS(i+1). Due to the feedback delay, the training symbols are not transmitted immediately before TS(i+1), but, as can be shown in the figure, a certain time before TS(i+1), so as to allow measurement data transmitted from the users to reach the base station and be processed by the scheduler during TS(i).

All base stations in the communication system must transmit training symbols employing the beamforming configuration that is going to be used in the next time slot during the same period, otherwise the measurement data will not be reliable, since, even though the signal strength may be high, the interference from other base stations may be sever at the same time. Accordingly, it is very important that the base stations in the system are well synchronised. The solution shown in FIG. 1 enables all users in the cell to assess the channel quality that will govern the transmission during the next time slot, provided that the radio channel does not fade too fast, and to report a channel quality measurement to the base station in advance. However, as can be seen in the figure, the measurement introduces a short pause in the data-transmission in each time slot, resulting in a considerable reduction of the data throughput, since the data transmission in the entire system must be paused during the training signal transmission

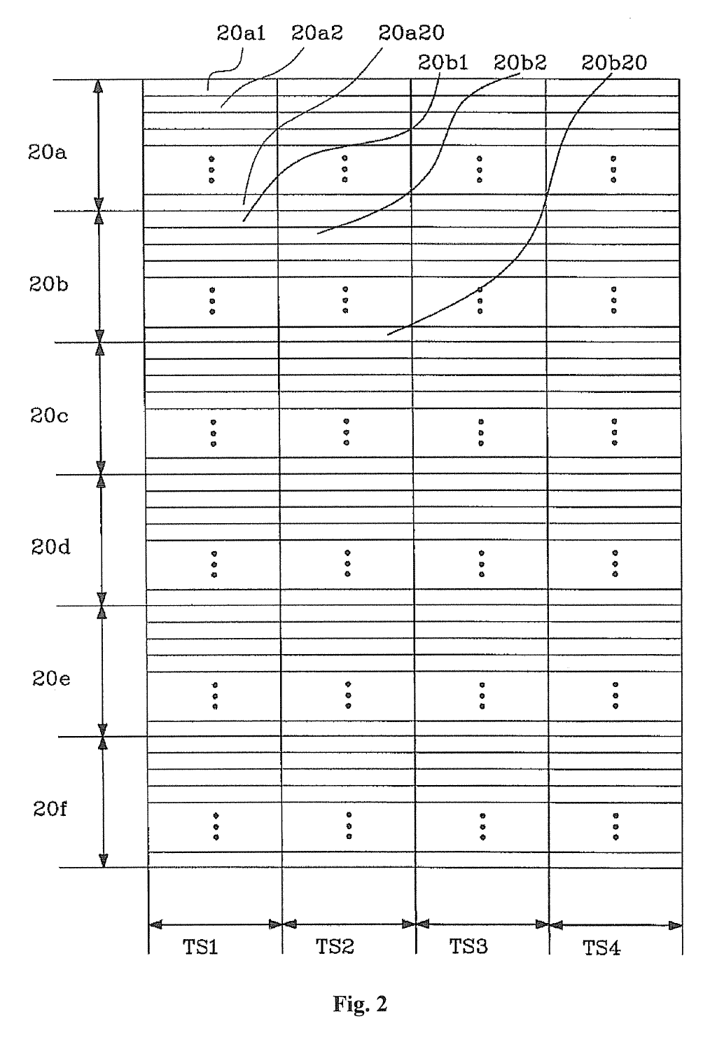

In FIG. 2 is shown a communication resource scheme suitable for use with one embodiment of the present invention. The disclosed system is a multiple-carrier OFDM system, having a two-dimensional structure (time and frequency). The frequency spectrum of the OFDM system is divided into a number of sub-bands 20a-20f, preferably constituting equal portions of the frequency spectrum. Equal frequency sub-bands are preferred to facilitate resource management (for example, it is easier to allocate the available resources). However, division into non-equal frequency sub-bands is, of course, also possible. Each sub-band is divided into a number of sub-carriers, for example, each sub-band may consist of 20 sub-carriers, e.g. 20a1-20a20, however, sub-bands consisting of any number of sub-carriers are possible, e.g., 1, 5, 100 or any other number.

In the time domain, the frequency spectrum is divided into time slots TS1, TS2, TS3, TS4, which typically, as can be seen in FIG. 3, has the length of a number of OFDM symbols. The frequency/time spectrum thus constitutes a communication resource scheme, wherein, in a system utilising random beamforming, the smallest resource allocated to a user is one sub-band during one time slot.

Most of the sub-carriers are used for carrying data, though, typically, some of the available sub-carriers are used as pilot sub-carriers. That is, they contain constellation (training) symbols, known by the receiver, and serve to make the receiver able to estimate the effect of the frequency-selective channel.

An exemplary embodiment of the present invention will be explained more in detail with reference to FIG. 3. In FIG. 3 is shown a number of timeslots TS1-TS8, and one sub-band for TS3 and TS4.

As can be seen in the figure, the sub-band consists of a plurality of sub-carriers. For simplicity, only one sub-band is shown, having 20 sub-carriers 301, 302, . . . , 320. However, as is understood by a person skilled in the art, the number of sub-carriers may be 20 as above, or any other number. Further, the number of sub-bands may be six as in FIG. 2 or any other number. In this example, each time slot TS1-TS8 has a length of four OFDM symbols. As in the system described in FIG. 1, the transmitter employs random beamforming on a slot by slot basis, that is, beamforming coefficients for the sub-carriers carrying data are changed from one time slot to the next and kept constant during the entire duration of the time slot. The beamforming coefficients during one time slot are the same for all sub-carriers in a sub-band, both data sub-carriers and pilot sub-carriers.

In the described example, sub-carriers S1-S4, S6-S20 are used for data transmission, while sub-carrier S4 is a pilot sub-carrier. Pilots symbols are inserted in a pilot sub-carrier for two separate purposes: on one hand there are pilot symbols used for channel estimation, i.e. a measurement performed by the receiver to be able to reliably decode symbols, and on the other hand there are pilot symbols for channel-quality estimation. Normally, separate pilot sub-carriers are used for these purposes, and they can be applied with independent power settings. Any channel estimation scheme in the user equipment must only use the pilots in the same time slot as the data that is demodulated. The channel estimation, however, will not be discussed further, and, therefore, pilot sub-carriers used for this purpose are not shown in the following description.

According to the described above, in order to enable the users in the cell to estimate their respective channel quality for a subsequent time slot, beamforming coefficients for the pilot sub-carrier S4 are the same as those used for the data sub-carriers S1-S3, S6-S20, except for one or a few OFDM symbols in the time slot. For this sub-carrier, beamforming coefficients are employed that will be valid for the data sub-carriers in the next or a future time slot. The data transmitted in sub-band portion S4 at least partly constitutes training symbols, which are known by the receiver.

In the exemplary embodiment shown in FIG. 3, each time slot consists of four OFDM symbols, and OFDM symbol no. 3 in sub-carrier S4 in each time slot is used to transmit training symbols with the beamforming constellation to be used in the next time slot, i.e., in time slot TS3, OFDM symbol no. 3, training symbols are transmitted using the beamforming constellation to be used in TS4.

In an alternative embodiment, training symbols can be transmitted using a beamforming constellation to be used in a later time slot, e.g., in TS3, the beamforming constellation to be used in TS6 could be transmitted, in TS4 the beamforming constellation of TS7 and so on.

The benefit of the structure according to the above transmission scheme is that the receiving unit will know the beamforming constellation for each sub-band that will apply in the next (or a predefined future) time slot. As compared to the prior art, this structure has the substantial advantage that it enables the users in the cell to estimate their respective channel quality for a next time slot without pausing the data transmission of the entire system, since data transmission in all other sub-carriers of the sub-band may proceed uninterrupted. Further, this has the advantage that it increases the throughput in the system.

The same sub-carrier in each sub-band may be used as pilot sub-carrier. As is obvious to a person skilled in the art, however, any sub-carrier in a sub-band may constitute a pilot sub-carrier. Further, two or more sub-bands may use the same beamforming constellation, in which case only one sub-carrier of any of these sub-bands needs to be used according to the present invention. Also, two or more sub-carriers in each sub-band may be utilised for transmission of training symbols.

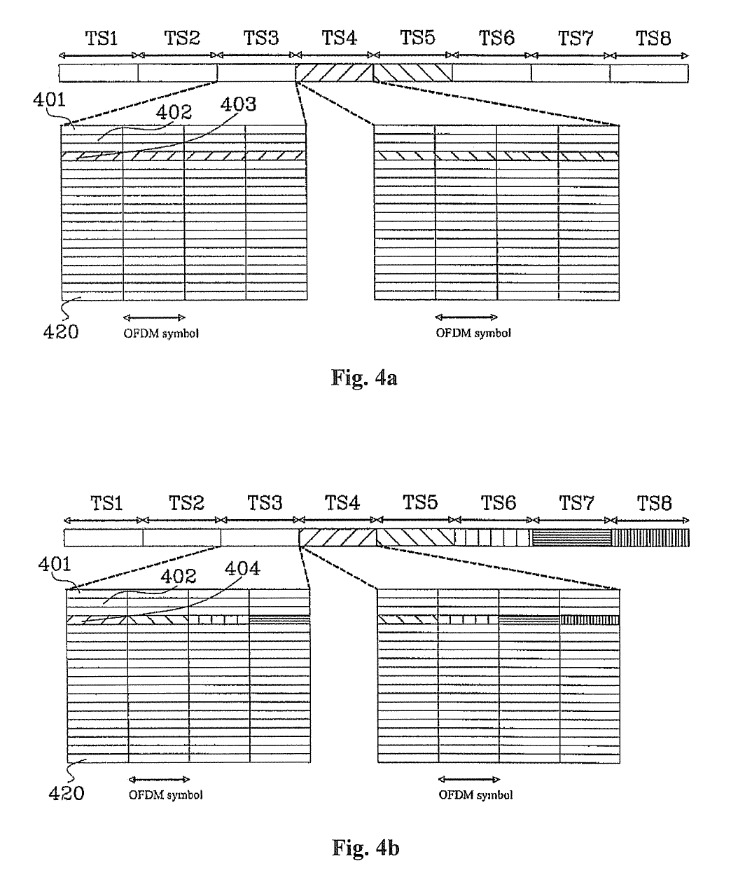

In FIG. 4a is shown an alternative exemplary embodiment of the present invention. Also this figure shows one sub-band during timeslots TS3 and TS4. As is shown in the figure, the sub-carrier S4 is used substantially as above. However, in this embodiment, not only one OFDM symbol is used to transmit training symbols using a beamforming constellation of a later time slot, but, instead, all OFDM symbols in the time slot is used to do this, e.g., as is shown, in TS3 sub-carrier S4 transmits training symbols using the beamforming constellation of TS4, in TS4 the beamforming constellation of TS5 and so on. This enables that a receiver may transmit a channel quality estimate to the base station, e.g. at the beginning of TS3, and then monitor the channel quality during TS3, and, if the receiver determines that the channel quality has changed by a certain amount, a second measurement may be transmitted. Accordingly, the measurement results may be used by the system to predict a likely channel quality of the receiver during the next time slot. Of course, three or more measurements may be transmitted during a time slot, making it even easier to obtain a reliable channel quality measurement, however with the disadvantage of increased signalling. As an alternative to transmitting detailed measurements, indications as to whether channel quality has improved or degraded since the first measurement may be transmitted instead. For example, each time channel quality improves or degrades with a predetermined value relative to the first measurement, an indication may be transmitted from the receiver.

Since it, according to the present invention, is possible to transmit training symbols during a longer period of time, i.e. one or a plurality of OFDM symbols, time-synchronisation between base stations is not nearly as important as in the prior art system.

In FIG. 4b is shown another exemplary embodiment of the present invention. Also in this embodiment, the sub-carrier is used substantially as described in FIG. 3, however instead of only transmitting the beamforming constellation to be used during, e.g., the immediately following time slot, beamforming constellations for the next four time slots are transmitted, i.e. in TS3 the first OFDM symbol is used for the beamforming constellation of TS4, the second OFDM symbol for the beamforming constellation of TS5, and so on. This makes it possible for channel quality measurements of users in the periphery of the cell, where transmission delay may be substantial, to be performed at such an early stage that they with certainty reaches base station in time for use by the scheduler.

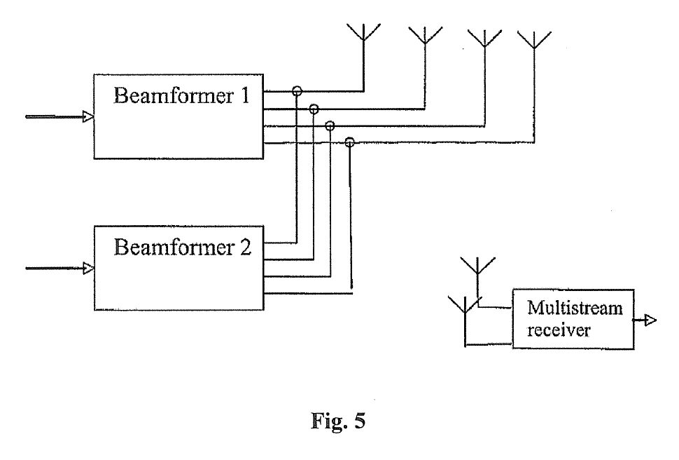

In FIG. 5 is shown a further embodiment according to the present invention. As described above, the entire frequency band is divided in sub-bands and where each sub-carrier carries multiple streams of data. In the system in FIG. 5, two pairs of antennas are used, wherein each pair transmit one data stream. In this embodiment, each antenna pair uses the same frequency band using the same sub-bands. Each sub-band and each data stream applies random beamforming independently and changes its beamforming constellation from one time slot to the next. This has the advantage that the two data streams may utilise the same frequency band at the same time in the same cell. Preferably, it is ensured in the system that the two beams from the two pairs of antennas never point in the same direction. This solution requires a receiver with two antennas in order to properly separate and detect the data streams. As is obvious to a person skilled in the art, any number of data streams may be concurrently transmitted in this way, such a system typically having at least N pairs of transmitter antennas where N is the number of data streams, and wherein the receiver has at least N receiver antennas.

In the above description the sub-carrier for transmitting the beamforming constellation(s) constitute part of the sub-band the beamforming constellation relates to. The sub-carrier, however, may equally well be located adjacent to the sub-band, as long as its frequency is substantially the same as the sub-band.

Further, in the above description random beamforming has been used. It is, of course, also possible to use a predetermined beamforming pattern, which preferably is cycled. For example, the cell may be divided into eight sectors, into which the beam cyclically is directed according to a predetermined pattern.

1. Method for channel quality estimation in a wireless data communication system, comprising:
transmitting data streams from a transmitter having multiple antennas and/or antenna elements to a receiver over a frequency band, wherein,
during a first period of time, transmitting data streams on at least one sub-band of the frequency band using a first beamforming constellation, and during a subsequent second period of time, transmitting data streams on said sub-band using a second beamforming constellation; wherein
during the first period of time, transmitting a data stream on a portion of, or adjacent to, said sub-band while using the beamforming constellation to be used in said second period of time.

2. Method as claimed in claims 1, wherein data streams are transmitted over a plurality of sub-bands, wherein each sub-band is assigned a beamforming constellation, and wherein at least one sub-band portion of each sub-band is at least partly used for data transmission while using a beamforming constellation to be used in a subsequent period of time.

3. Method as claimed in claim 2, wherein at least two sub-bands are assigned the same beamforming constellation.

4. Method as claimed in claim 1, wherein said data streams are transmitted in a time slot structure, wherein said first period of time is a first time slot and wherein said second period of time is a second time slot following said first time slot, and wherein the beamforming constellation is changed each time slot or after a predetermined number of time slots.

5. Method as claimed in claim 1, wherein the data transmitted in said sub-band portion at least partly constitutes training symbols, which are known by the receiver.

6. Method as claimed in claim 1, further comprising:
transmitting at least two data streams simultaneously in a sub-band, wherein said beamforming constellation is different for each data stream.

7. Method as claimed in claim 1, wherein said beam forming constellations are determined using random beamforming or a beamforming pattern.

8. Method as claimed in claim 1, further comprising transmitting a channel quality estimate from the receiver to the transmitter prior to said second period of time/time slot.

9. Method as claimed in claim 8, wherein at least two measurements is transmitted from the receiver during the time interval data is transmitted using a beamforming constellation of the second period of time/time slot.

10. Method as claimed in claim 8, wherein at least one indication as to whether channel quality has improved or degraded since a measurement was transmitted to the system is transmitted to the transmitter.

11. System for channel quality estimation in a wireless data communication system, comprising:
means for transmitting data streams from a transmitter having multiple antennas and/or antenna elements to a receiver over a frequency band;
means for transmitting data streams during a first period of time on at least one sub-band of the frequency band using a first beamforming constellation;
means for transmitting data and/or data streams during a second period of time, following said first period of time, on said sub-band using a second beamforming constellation; and
means for, during the first period of time and on at least one sub-band portion of, or adjacent to, said sub-band, transmitting a data stream using the beamforming constellation to be used in said second period of time.

12. System as claimed in claim 11, wherein further comprising means for transmitting data over a plurality of sub-bands, wherein each sub-band is assigned a beamforming constellation, and wherein at least one sub-band portion of each sub-band is at least partly used for transmission using a beamforming constellation to be used in a subsequent period of time.

13. System as claimed in claim 12, wherein at least two sub-bands are assigned the same beamforming constellation.

14. System as claimed in claim 11, wherein the system includes means for transmitting data streams in a time slot structure, wherein said first period of time is a first time slot and wherein said second period of time is a second time slot following said first time slot, and wherein the system further includes means for changing the beamforming constellation each time slot or after a predetermined number of time slots.

15. System as claimed in claim 11, wherein the data transmitted in said sub-band portion at least partly constitutes training symbols, which are known by the receiver.

16. System as claimed in claim 11, further comprising means for transmitting at least two data streams simultaneously in a sub-band, wherein said beamforming constellation is arranged to be different for each data stream.

17. System as claimed in claim 11, wherein said beamforming constellations are determined using random beamforming or a beamforming pattern.

18. System as claimed in claim 11, wherein the receiver is arranged to transmit a channel quality estimate to the transmitter prior to said second period of time/time slot.

19. System as claimed in claim 18, wherein the receiver is arranged to transmit at least two measurements during the time interval data is transmitted using a beamforming constellation of the second period of time/time slot.

20. System as claimed in claim 18, wherein when a measurement has been sent to the transmitter, the receiver is arranged to transmit at least one indication as to whether channel quality has improved or degraded since the measurement transmission.

21. Transmitter for use in a system according to claims 11, characterized in that it is arranged to, during a first period of time and on at least one sub-band portion of a sub-band, transmit data using a beamforming constellation to be used in a second period of time.

22. A multi-user cellular communication system having communication resources for communication between at least one transmitter and one receiver, characterized in that said communication system includes at least one transmitter as claimed in claim 21.
